(19) United States
(12) Patent Application Publication
(10) Pub. No.: US 2009/0016404 A1
(43) Pub. Date: Jan. 15, 2009

(54) INTELLIGENT THERMOMETER

(75) Inventors: Weisong Wang, Westford, MA (US); Fang Lu, Billerica, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/777,320

(22) Filed: Jul. 13, 2007

(51) Int. Cl. G01K 13/00

(52) U.S. Cl. 374/141; 600/549

(57) ABSTRACT

A device for measuring the body temperature of a user is provided. The device comprises a casing having an opening; a sensing device extending from the opening of the casing, the sensing device configured for measuring the body temperature of the user and generating an output signal when the sensing device is received by the user, the output signal indicative of the body temperature of the user; and a controller in electrical communication with the sensing device, the controller configured to receive the output signal and to calculate a temperature reading representative of the body temperature of the user, the controller further configured to determine whether the temperature reading is within one of a plurality of temperature ranges based on the age of the user, and the controller further configured to generate a dosage amount of a plurality of medicines based on the age of the user and weight of the user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a thermometer for measuring the body temperature of a child, and particularly to a thermometer configured for calculating whether a child has a fever based on the age of the child and providing dosing information for a variety of medicines that can be administered to the child based on the age and weight of the child.

2. Description of Background

Thermometers of various types are commonly used to measure the body temperature of a child. Thermometers typically have an indicating means (e.g., digital reading via a screen) that illustrates the body temperature of the child after the temperature of the child is taken. Once the body temperature is known, a user decides what pediatric medicine to administer to the child.

Children of different ages have different temperature thresholds for a fever. Here are some examples: A baby of less than three months is said to have a fever starting from 100.4 F.; between three to six months of age, the threshold rises to 101 F.; a child older than six months has a fever when the temperature reaches above 103 F.

Furthermore, when children are sick, they need to take different doses of medicines depending on their age and weight. All of this information is critical in order to provide adequate care. Obviously, it can be confusing and hard to remember for new parents.

For this reason, the inventors herein have recognized that having a thermometer configured to determine whether a child has a fever and generate dosing information for a plurality of medicines that can be administered to the child and a method thereof can lessen or eliminate the confusion and hardship for new parents and old parent alike.

### SUMMARY OF THE INVENTION

The shortcomings of the prior art are overcome and additional advantages are provided through the provision of a device for measuring the body temperature of a user, the device comprising: a casing having an opening; a sensing device extending from the opening of the casing, the sensing device configured for measuring the body temperature of the user and generating an output signal when the sensing device is received by the user, the output signal indicative of the body temperature of the user; and a controller in electrical communication with the sensing device, the controller configured to receive the output signal and to calculate a temperature reading representative of the body temperature of the user, the controller further configured to determine whether the temperature reading is within one of a plurality of temperature ranges based on the age of the user, and the controller further configured to generate a dosage amount of a plurality of medicines based on the age of the user and weight of the user.

The shortcomings of the prior art are overcome and additional advantages are provided through the provision of a device for measuring the body temperature of a user, the device comprising: a casing having an opening; a sensing device extending from the opening of the casing, the sensing device configured for measuring the body temperature of the user and generating an output signal when the sensing device is received by the user, the output signal being indicative of the body temperature of the user; a controller in electrical communication with the sensing device, the controller configured to receive the output signal and to calculate a temperature reading representative of the body temperature of the user, the controller further configured to determine whether the temperature reading is within one of a plurality of temperature ranges based on the age of the user, and the controller further configured to generate a dosage amount of a plurality of medicines based on the age of the user and weight of the user; and a display screen in electrical communication with the controller for displaying the dosage amount of each of the plurality of medicines.

The shortcomings of the prior art are overcome and additional advantages are provided through the provision of a method for determining whether a user has a fever and generating dosing information for a plurality of medicines, the method comprising: measuring the body temperature of the user through a sensing element; generating an output signal, the output signal being indicative of the body temperature of the user; calculating a temperature reading representative of the body temperature of the user through a controller, the controller being in electrical communication with the sensing element; determining whether the temperature reading is within one of a plurality of temperature ranges based on the age of the user through the controller; and generating a dosage amount for the plurality of medicines based on the age of the user and the weight of the user through the controller.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that calculates whether a child has a fever and provides information on the proper dosing of common over-the-counter pediatric medicine that can be administered to the child.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a screen shot of an LCD of a thermometer prompting a user to enter the current date;

FIG. 2 illustrates one example of a screen shot of the LCD of the thermometer prompting the user to enter the current time;

FIG. 3 illustrates one example of a screen shot of the LCD of the thermometer prompting the user to enter the name of a child;

FIG. 4 illustrates one example of a screen shot of the LCD of the thermometer prompting the user to enter the birth date of the child;

FIG. 5 illustrates one example of a screen shot of the LCD of the thermometer prompting the user to enter the weight of the child;

FIG. 6 illustrates one example of a screen shot of the LCD of the thermometer prompting the user to enter information for another child;

FIG. 7 illustrates one example of a screen shot of the LCD of the thermometer displaying dosage information of a variety of medicines that can be administered to the child;

FIG. 8 illustrates one example of a screen shot of the LCD of the thermometer displaying a list of the names of children saved in the thermometer; and

FIG. 9 illustrates one example of a flowchart of the operation of the thermometer.

The detailed description explains the preferred embodiments of the invention, together with advantages and features, by way of example with reference to the drawings.

### DETAILED DESCRIPTION OF THE INVENTION

Exemplary embodiments of a thermometer and a method of using the same in accordance with the present invention will now be described with reference to the drawings. The exemplary embodiment of a thermometer described herein is configured to calculate a temperature reading representative of the body temperature of a child and to determine whether the temperature reading is within a normal temperature range, an elevated temperature range, or a fever temperature range based on the age of the child. The exemplary embodiment of the thermometer described herein is further configured to provide dosing information of a variety of medicines that can be administered to the child based on the age and weight of the child.

For simplistic purposes, exemplary embodiments of a thermometer in accordance with the present invention will be described in greater detail with respect to a child or infant; however, it is contemplated that the disclosed embodiments of the thermometer could be configured for all user types (e.g., adults).

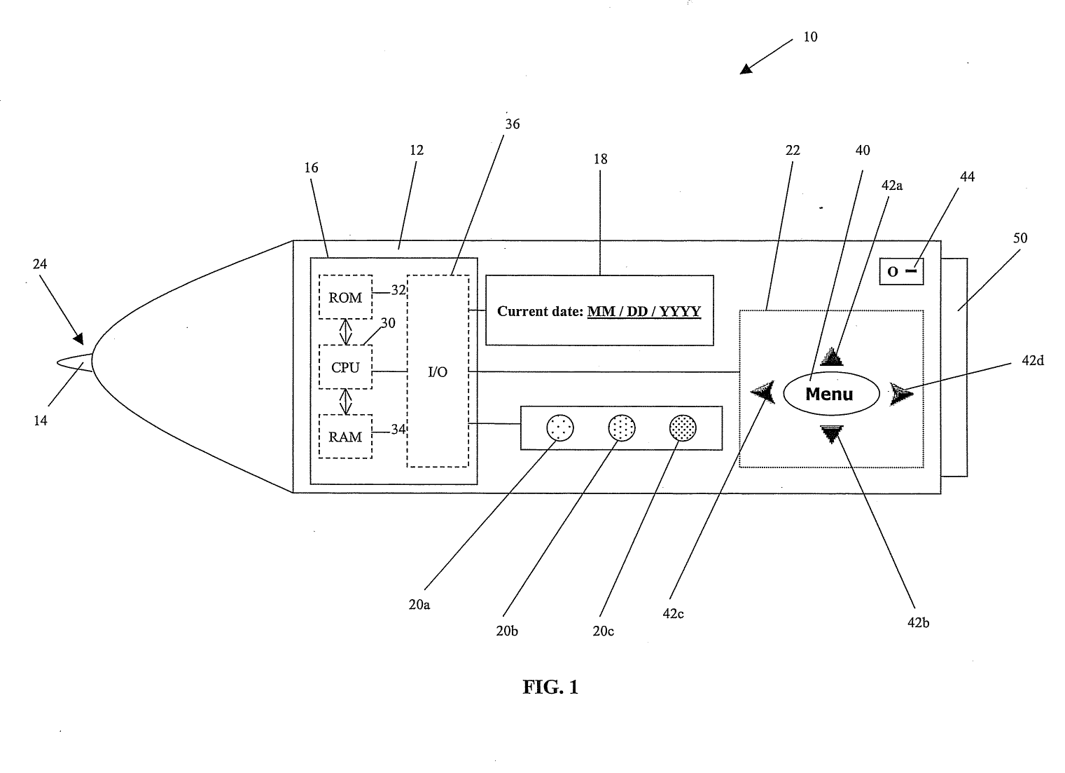

Referring now to FIG. 1, a thermometer 10 in accordance with one embodiment of the present invention is provided. The thermometer 10 includes a casing 12, a sensing element 14, a controller 16, a liquid crystal display (LCD) screen 18, light indicators 20a, 20b, 20c, and a menu pad 22. In one embodiment, casing 12 of thermometer 10 houses sensing element 14, controller 16, LCD screen 18, light indicators 20a, 20b, 20c, and menu pad 22 and in one non-limiting embodiment is constructed out of a plastic material. Of course, other types of materials could be used to construct casing 12.

In one embodiment, casing 12 has an opening 24. A portion of the sensing element 14 extends from opening 24 of casing 12 while another portion is housed within casing 12 in accordance to one embodiment of the present invention. The sensing element 14 is made of a highly conductive material, such as brass, and is generally located at one end of casing 12 to contact with a child and measure the body temperature of the child. Of course, other highly conductive materials can be used to construct sensing element 14 and should not be limited to the example described above. The sensing element 14 is in electrical communication with controller 16. The sensing element 14 is configured to generate an output signal when a child receives the sensing element 14. In other words, sensing element 14 generates an output signal after the body temperature of the child is taken. The output signal is directly indicative of the body temperature of the child.

In one embodiment, controller 16 is provided to receive the output signal from the sensing element 14 and calculate a temperature reading representative of the body temperature of the child. The controller 16 is further provided to determine whether the child has a fever in accordance to one embodiment of the present invention. The controller 16 is further provided to generate dosage information of a variety of common over-the-counter pediatric medicine (e.g., Infant Tylenol) that may be administered to the child based on the age and weight of the child, which will further be described in greater detail below.

In one non-limiting embodiment, controller 16 is in electrical communication with LCD screen 18 and is provided to control the operation of LCD screen 18 such that LCD screen 18 displays the temperature reading calculated by controller 16. In another non-limiting embodiment, controller 16 is in electrical communication with light indicators 20a, 20b, 20c and is provided to control the operation of light indicators 20a, 20b, 20c. In one embodiment, the controller 16 includes a central processing unit (CPU) 30, a read-only memory (ROM) 32, a volatile memory such as a random access memory (RAM) 34, and an input/output (1/0) interface 36, which is electrically coupled to sensing element 14, LCD screen 18, and menu pad 22. The CPU 30 operably communicates with the ROM 32, the RAM 34, and 1/0 interface 36. The computer readable media including ROM 32 and RAM 34 may be implemented using any of a number of known memory devices such as PROMs, EPROMs, EEPROMs, flash memory or any other electric, magnetic, optical or combination memory device capable of storing data, some of which represent executable instructions used by CPU 30.

In one embodiment, controller 16 determines whether the temperature reading of the child is within a normal range, an elevated range, or a fever range and turns on one of light indicators 20a, 20b, 20c that reflect whether the temperature of the child is normal, elevated, or indicates a fever, respectively according to the temperature reading and age of the child. More specifically, light indicator 20a lights up when the temperature reading is within the normal range, thus indicating a normal temperature. Light indicator 20b lights up when the temperature reading is within the elevated range, thus indicating an elevated temperature. Light indicator 20c lights up when the temperature reading is within the fever range, thus indicating a fever. The temperature readings within the normal range, elevated range, and fever range are determined based on the age of the child, thus change accordingly. Children of different ages have different temperature thresholds for a fever. As such, the temperature ranges for a child being less than three months of age are different from the temperature ranges for a child between three to six months of age. In one non-limiting embodiment, the temperature threshold for a child that is less than three months begins from approximately 100.4° F. (Fahrenheit), whereas a child between three to six months of age begins from approximately 101° F. In other words, a child that is less than three months of age is considered to have a fever if their measured body temperature is greater than 100.4° F. and a child that is between three to six months of age is considered to have a fever if their measured body temperature is greater than 101° F. As such, for a child that is less than three months of age, the normal range is between approximately 0° F.-98.6° F. (inclusive) and the elevated range is between approximately 98.7° F.-100.3° F. (inclusive) in accordance with one embodiment of the present invention. The normal range and the elevated range are different for a child that is between three to six months of age. In one embodiment, the temperature thresholds and corresponding ranges are based on the AAP's (American Academy of Pediatrics) standard and stored in ROM 32 and/or RAM 34 of controller 16 and retrieved from the same accordingly. Of course, other standards could be used to determine the temperature thresholds and corresponding ranges.

In one embodiment, menu pad 22 is provided for the user to manually input information relating to the child. The menu pad 22 is in electrical communication with controller 16, which controls the operation of LCD screen 18 where the user can view the input information relating to the child in accordance to one embodiment of the present invention. In one embodiment, menu pad 22 includes a menu command button 40 and navigation buttons 42a, 42b, 42c, 42d. The operation of menu pad 22 along with LCD screen 18 with respect to how the user inputs and views information relating to the child will become more apparent with the description below.

In one embodiment, LCD screen 18 is provided to display calculated information, such as, for example, the temperature reading and the dosage amount of each of the variety of medicines that may be administered to the child. The LCD screen 18 is also provided to prompt the user in entering information in a number of fields (e.g., birth date). The information entered is used to determine whether or not the child has an elevated temperature, normal temperature, or a fever as well as the dosage amount of the variety of medicines generated by controller 16. The fields of information include, for example, the birth date, name of the child, weight of the child, as well as the current time and date. In one embodiment, the user manually enters the information by using menu command button 40 and navigation buttons 42a, 42b, 42c, 42d. In one non-limiting embodiment, the user enters the current date by using navigation button 32a and 32b, referred to as the up arrow key and down arrow key respectively. In one embodiment, navigation button 32a increments the digits while navigation button 32b decrements the digits. A cursor on the LCD screen 18 moves from the left to the right of the screen as the user enters information. In one non-limiting embodiment, the user uses navigation button 32c and 32d, referred to as the left arrow key and right arrow key respectively to move from one field to another (e.g., from birth date to the weight of the child). In one embodiment, the user presses menu command button 40 to select the desired digit or letter. In one embodiment, the user accesses the dosage information of the variety of medicines by pressing one of the navigation buttons 42a, 42b, 42c, 42d, such as navigation button 42d (right arrow button) until such field is displayed. The proper dosing amount of each medicine is automatically displayed via LCD screen 18. In one exemplary embodiment, if there is certain medicine not recommended for the child, then it is indicated via LCD screen 18 as N/A (not applicable).

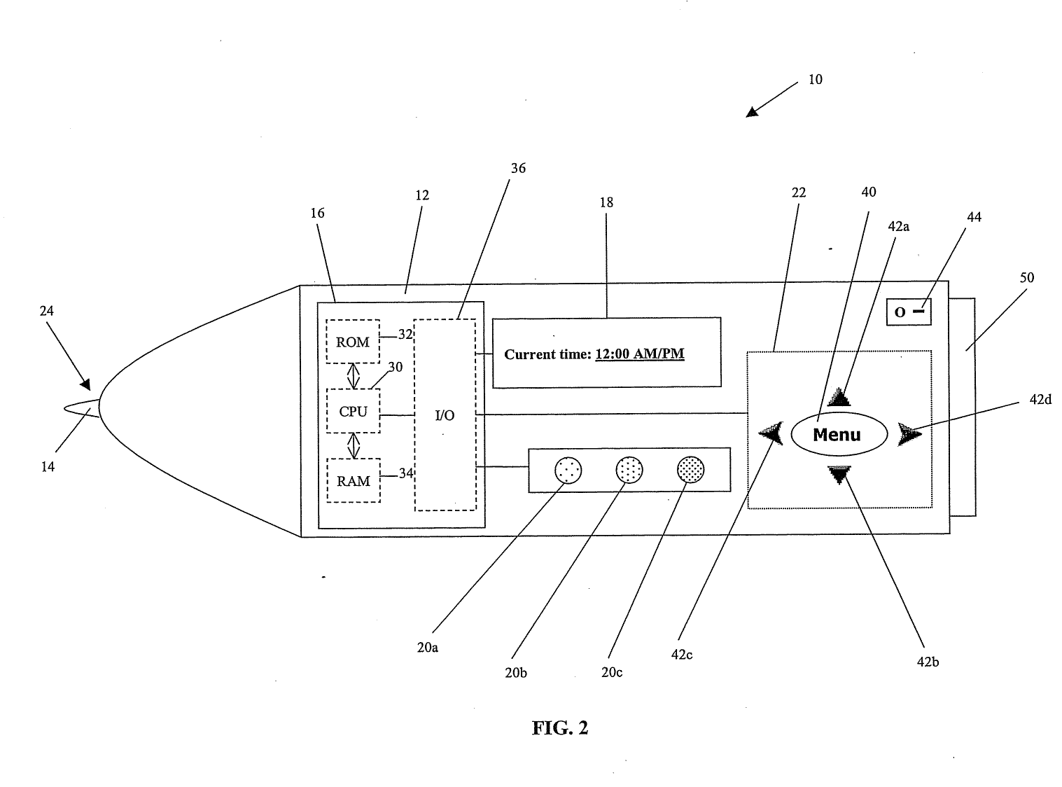

Now referring to FIGS. 1-8 illustrating exemplary screen shots of LCD screen 18 when thermometer 10 is operated. In operation, when thermometer 10 is turned on via a power button 44, the user is prompted via LCD screen 18 to enter basic information and information relating to the child. The user is prompted to enter the current date as illustrated in FIG. 1. The current date is entered in the MM/DD/YYYY format in accordance to one non-limiting embodiment of the present invention. Of course, other formats can be used to enter the current date and should not be limited to the example as shown. In one embodiment, the user enters the current date by using navigation buttons 32a and 32b as described above. The user presses menu command button 30 to select the desired digit. The user uses navigation button 32c and 32d to move to another field. The user is also prompted to enter the current time as illustrated in FIG. 2 using menu command button 30 and navigation button 32a and 32b in a similar fashion as described above. In doing so, each time thermometer 10 is operated, the age of the child is updated, and depending on the time that passed since the last update, the user will be prompted to update the weight of the child. Once the current date and time is entered, the user will not need to enter this information again in accordance to one exemplary embodiment of the present invention.

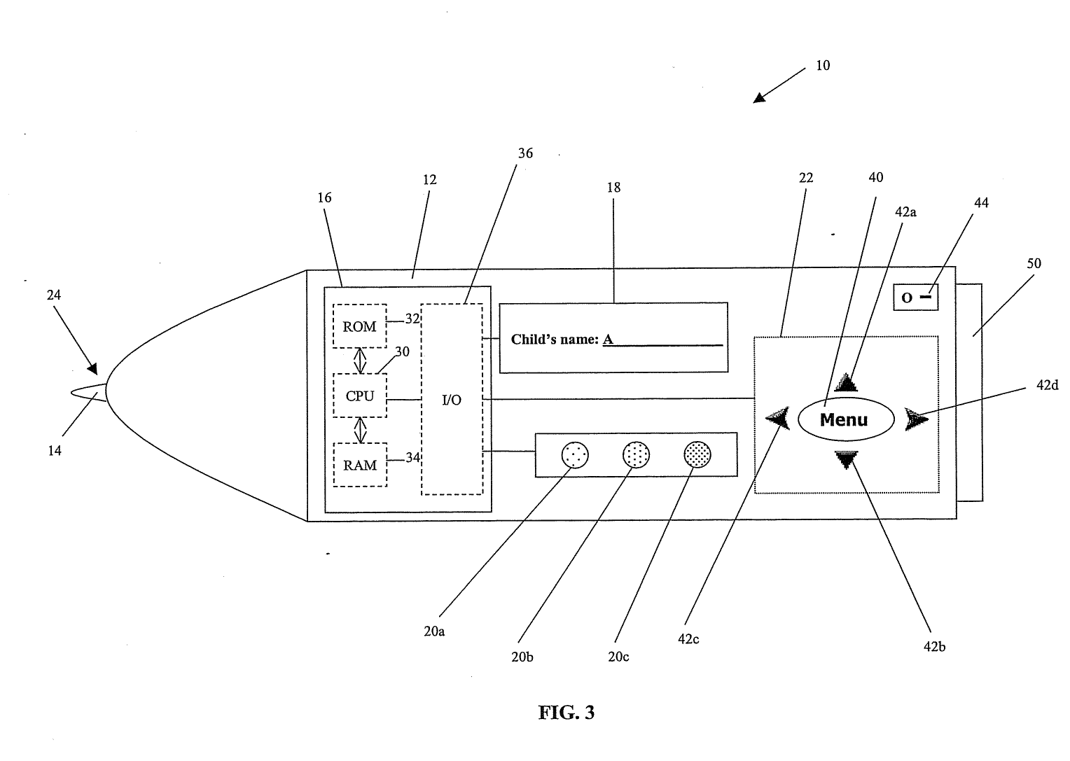

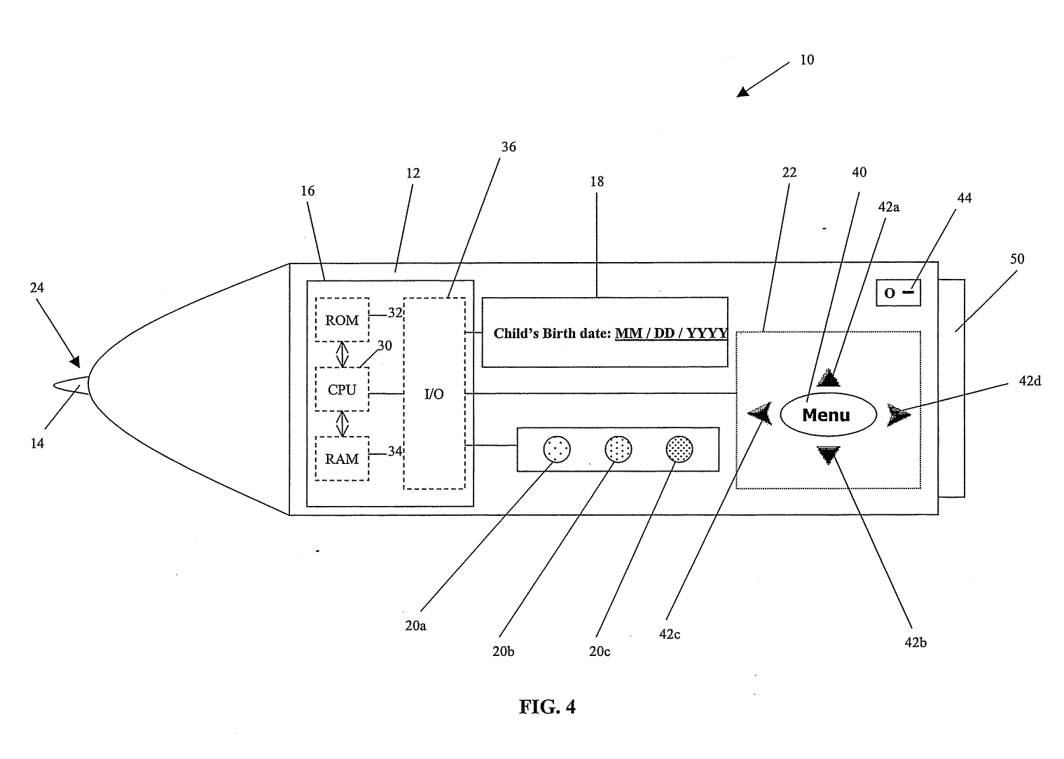

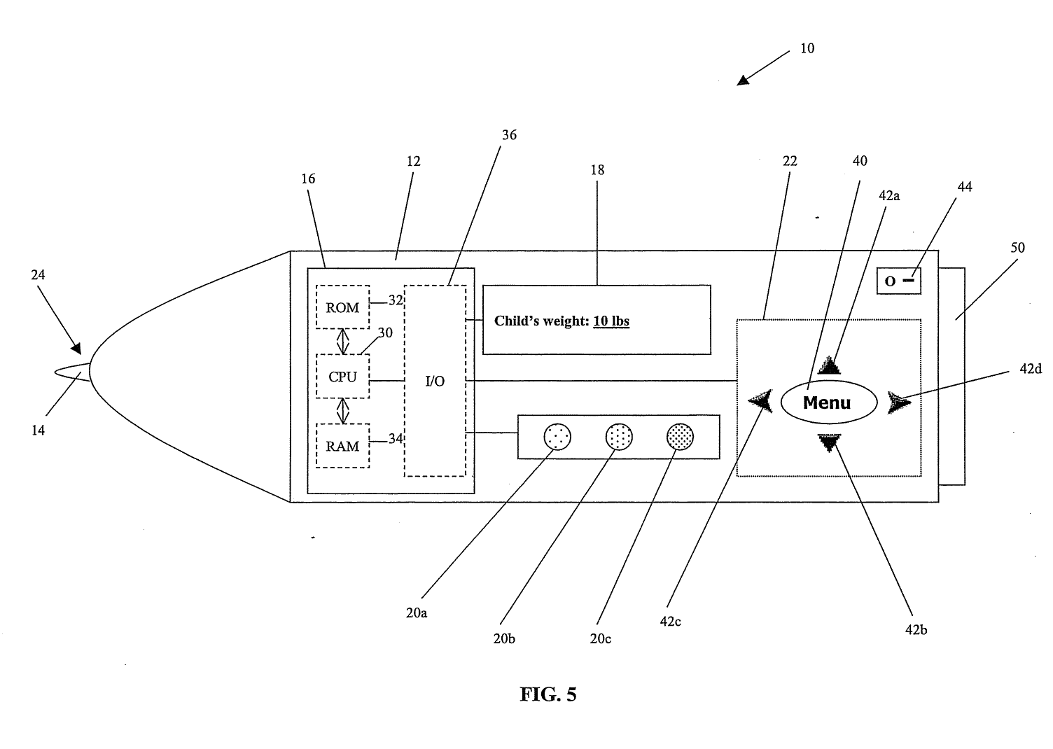

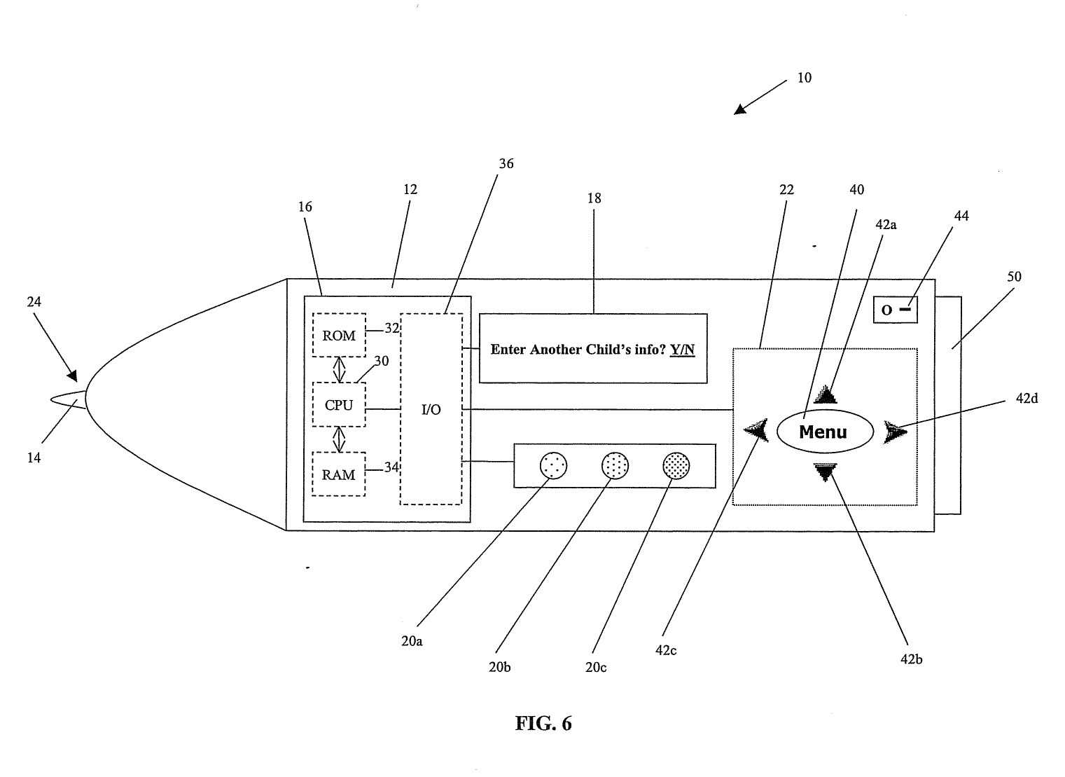

The user is also prompted to enter the name of the child as shown in FIG. 3 in accordance to one embodiment. As such, thermometer 10 can be used for more than one child. When the cursor starts at a new position, letter A is displayed at that position as shown. The user uses navigation button 32a and 32b to change the letter. The user presses menu command button 30 to select the desired letter. The user is also prompted to enter the birth date of the child as illustrated in FIG. 4 in accordance to one embodiment. The birth date is entered in the MM/DD/YYYY format in accordance to one exemplary embodiment of the present invention. Of course, other formats can be used to enter the birth date of the child and should not be limited to the example as shown. The user is also prompted to enter the weight of the child as illustrated in FIG. 5 using navigation button 32a and 32b in accordance to one embodiment. The user is also prompted to enter another child if desired as illustrated in FIG. 6. The user can use navigation button 32c and 32d to select Yes or No. If the user selects Yes, then the screen shots illustrated in FIGS. 3-5 will be displayed again prompting the user to enter information relating to the additional child. If the user selects No, then the user can begin taking the body temperature of the child via sensing element 14. The information (e.g., birth date, name, and weight) prompted via LCD 18 as described above is in no particular order and should not be limited to the order as described. For example, the weight of the child can be prompted before the birth date of the child.

Once the body temperature of the child is taken via sensing element 14, sensing element 14 sends an output signal indicative of the body temperature to controller 16. Controller 16 calculates a temperature reading representative of the body temperature of the child and determines whether the temperature reading of the child is within the normal range, elevated range, or fever range and turns on one of the light indicators 20a, 20b, 20c depending on the age of the child. As such, the user will be informed whether the temperature of the child qualifies as a fever or not. In one embodiment, light indicator 20a is a green light indicating that the temperature reading is within the normal range, while light indicator 20b is a yellow light indicating that the temperature reading is within the elevated range—but not yet a fever. Light indicator 20c is a red light indicating a fever in accordance with one embodiment of the present invention.

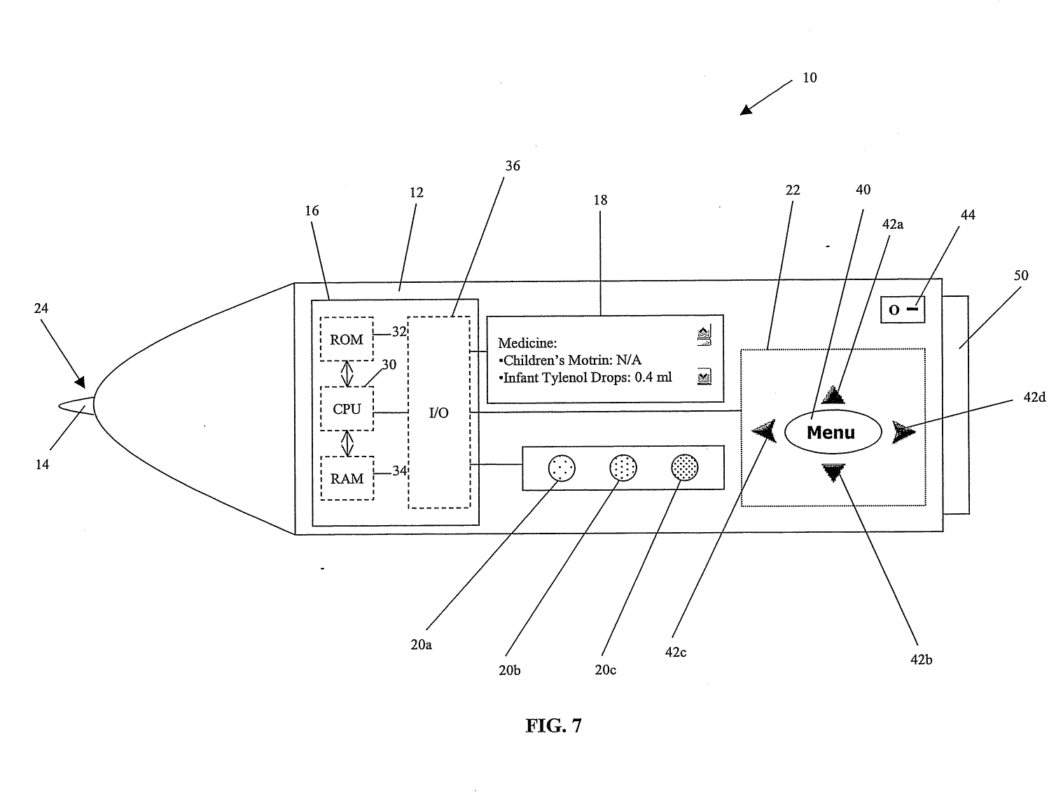

If light indicator 20c is turned on, the user can access dosage information of a variety of medicines by pressing one of the navigation buttons, such as navigation button 42d. As illustrated in FIG. 7, LCD 18 displays the recommended dosing information for a variety of medicines based on the age and weight of the child. If there is certain medicine that is not recommended for the child, then it is indicated as N/A. Otherwise, a list of the dosage amount for each medicine can be viewed via LCD screen 18.

In one embodiment, the user can update information regarding new medicines to thermometer 10 by downloading the information from a website, such as the American Academy of Pediatrics site. In one embodiment, the information from the Internet can be downloaded to thermometer 10 via an interface median 50, such as, for example, a USB port. As such, thermometer 10 can provide the user with dosage information of current medicines.

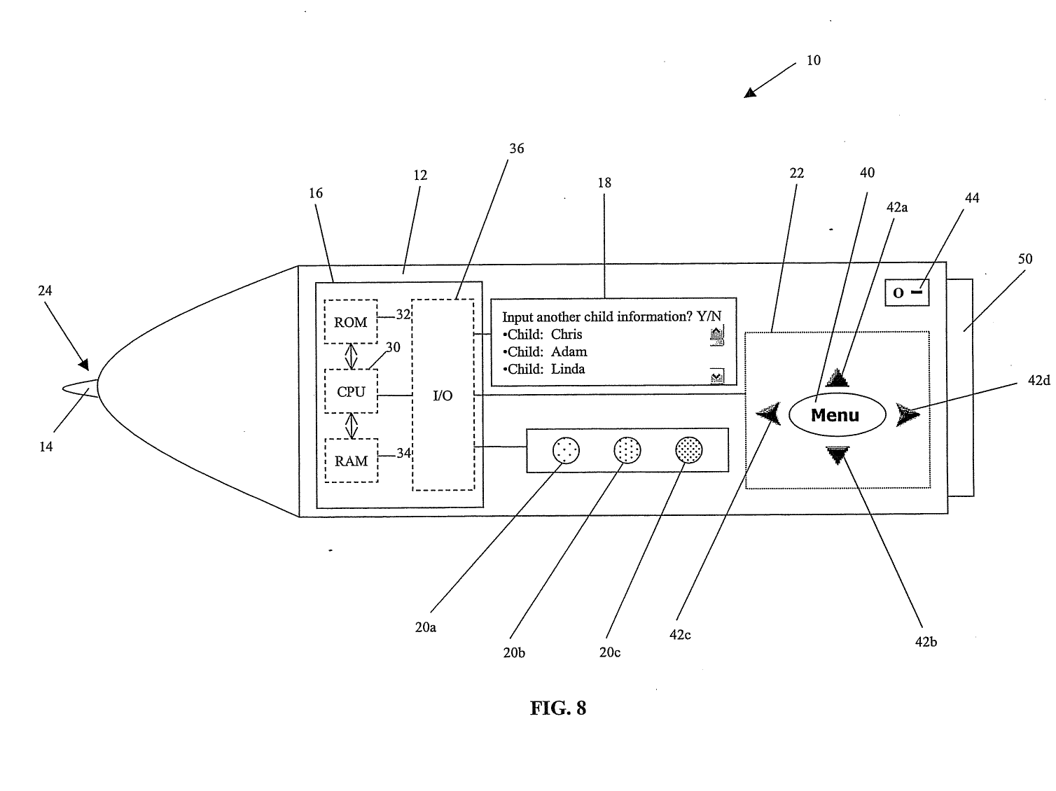

After the thermometer is operated and information pertaining to the child has been entered, the next time the user operates thermometer 10, LCD 18 will display the name of the child entered previously. If the user enters one or more names of a child, then a list of all the names will be displayed via LCD as illustrated in FIG. 8. In one embodiment, a scrollbar will be automatically displayed via LCD screen 18 in which the user scrolls up and down using navigation buttons 42a and 42b to navigate through the list of names. The user may also add more names of children to the list any time during the operation of thermometer 10 in accordance to one embodiment of the present invention. Otherwise, the user may begin taking the body temperature of the child listed on the LCD screen 18, unless information, such as, the weight of that child needs to be updated.

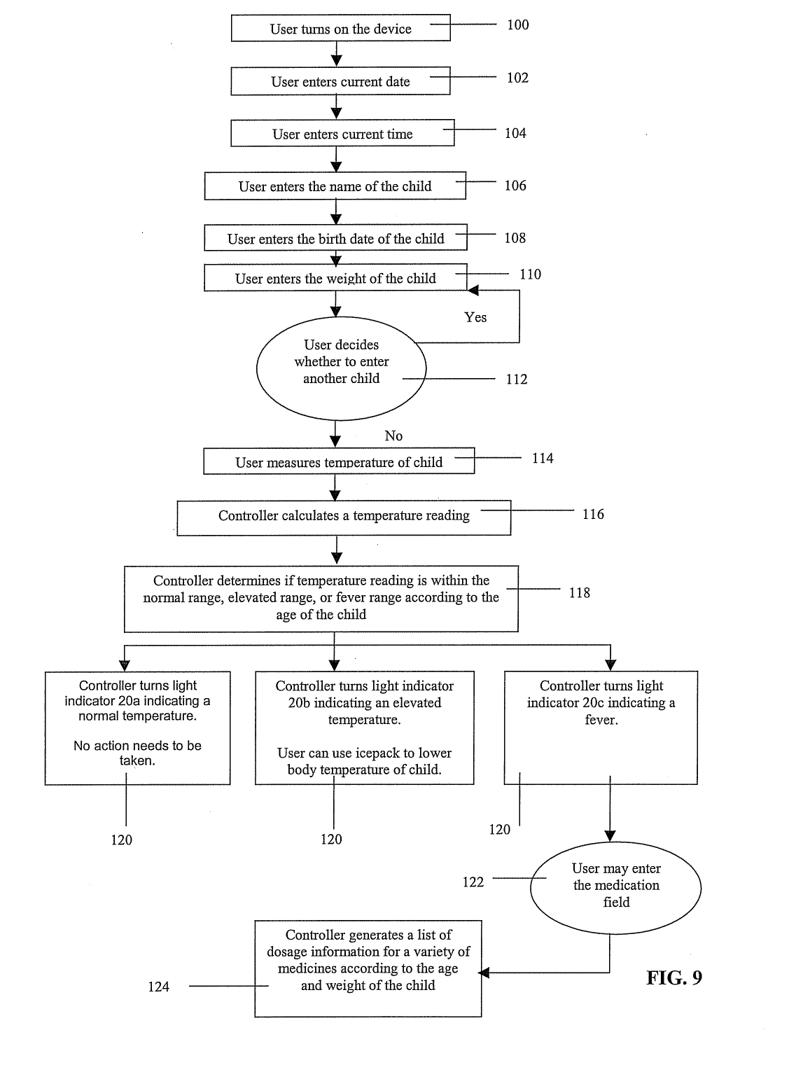

In accordance with one embodiment of the present invention, an exemplary method for measuring the temperature of a child and determining whether the child has a fever is illustrated in an exemplary flowchart in FIG. 9. The method can be implemented utilizing software algorithms executed by controller 16 of thermometer 10.

At step 100, a user begins the operation of thermometer 10. At step 102, the user enters the current date. At step 104, the user enters the current time. At step 106, the user enters the name of the child. At step 108, the user enters the birth date of the child. At step 110, the user enters the weight of the child. At step 112, the user decides whether to enter another child. If the user decides to enter more than one child, the user must run through steps 106-110 for the newly entered child. If the user decides not to enter another child, then the body temperature of the child can be taken via sensing element 14 at step 114. At step 116, controller 16 calculates a temperature reading. At step 118, controller 16 determines whether the temperature reading is within the normal range, elevated range, or fever range. At step 120, controller 16 turns on one of the light indicators 20a, 20b, 20c that represent the normal range, elevated range, and fever range respectively. Light indicator 20a is turned on when the temperature reading is within the normal range. Light indicator 20b is turned on when the temperature reading is within the elevated range. Light indicator 20c is turned on when the temperature reading is within the fever range. When the temperature reading indicates that the child has a fever, user enters into the medication field at step 122. At step 124, controller 16 generates dosage information for a variety of medicines.

In one embodiment, a reset field is provided for the user to reset the information regarding a particular child. In an alternative embodiment, a reset button (not shown) is located on thermometer 10 for resetting information.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A device for measuring the body temperature of a user, the device comprising:
a casing having an opening;
a sensing device extending from the opening of the casing, the sensing device configured for measuring the body temperature of the user and generating an output signal when the sensing device is received by the user, the output signal indicative of the body temperature of the user; and
a controller in electrical communication with the sensing device, the controller configured to receive the output signal and to calculate a temperature reading representative of the body temperature of the user, the controller further configured to determine whether the temperature reading is within one of a plurality of temperature ranges based on the age of the user, and the controller further configured to generate a dosage amount of a plurality of medicines based on the age of the user and weight of the user.

2. The device as in claim 1, further comprising a display screen in electrical communication with the controller for displaying the dosage amount of each of the plurality of medicines.

3. The device as in claim 1, wherein the plurality of temperature ranges comprises: a first temperature range indicative of a normal temperature reading, a second temperature range indicative of an elevated temperature reading, and a third temperature range indicative of a fever.

4. The device as in claim 1, wherein the controller activates at least one of a plurality of indicators based on the temperature reading and the age of the user, each of the plurality of indicators represents one of the plurality of temperature ranges.

5. The device as in claim 1, further comprising a plurality of command buttons being configured for entering information relating to the user in a plurality of data fields.

6. The device as in claim 5, wherein the plurality of data fields comprises: the name of the user, the age of the user, the weight of the user, or a combination thereof.

7. A device for measuring the body temperature of a user, the device comprising,
a casing having an opening;
a sensing device extending from the opening of the casing, the sensing device configured for measuring the body temperature of the user and generating an output signal when the sensing device is received by the user, the output signal being indicative of the body temperature of the user;
a controller in electrical communication with the sensing device, the controller configured to receive the output signal and to calculate a temperature reading representative of the body temperature of the user, the controller further configured to determine whether the temperature reading is within one of a plurality of temperature ranges based on the age of the user, and the controller further configured to generate a dosage amount of a plurality of medicines based on the age of the user and weight of the user; and
a display screen in electrical communication with the controller for displaying the dosage amount of each of the plurality of medicines.

8. The device as in claim 7, wherein the controller activates at least one of a plurality of indicators based on the temperature reading and the age of the user, each of the plurality of indicators represents one of the plurality of temperature ranges.

9. The device as in claim 7, further comprising a plurality of command buttons being configured for entering information relating to the user in a plurality of data fields.

10. The device as in claim 9, wherein the plurality of data fields comprises: the name of the user, the age of the user, the weight of the user, or a combination thereof.

11. A method for determining whether a user has a fever and generating dosing information for a plurality of medicines, the method comprising:
measuring the body temperature of the user through a sensing element;
generating an output signal, the output signal being indicative of the body temperature of the user;
calculating a temperature reading representative of the body temperature of the user through a controller, the controller being in electrical communication with the sensing element;
determining whether the temperature reading is within one of a plurality of temperature ranges based on the age of the user through the controller; and
generating a dosage amount for the plurality of medicines based on the age of the user and the weight of the user through the controller.

12. The method as in claim 11, further comprising displaying the dosage amount of each of the plurality of medicines through a display screen, the display screen being in electrical communication with the controller.

13. The method as in claim 11, further comprising activating at least one of a plurality of indicators through the controller based on the temperature reading and the age of the user.

14. The method as in claim 11, further comprising entering information relating to the user in a plurality of data fields.

15. The method as in claim 11, wherein the plurality of data fields comprises: the name of the user, the age of the user the weight of the user, or a combination thereof.
